(19) United States
(12) Patent Application Publication
(10) Pub. No.: US 2008/0143885 A1
(43) Pub. Date: Jun. 19, 2008

(54) Television upconverter structures

(75) Inventor: James C. Camp, Greensboro, NC (US)

Correspondence Address: KOPPEL, PATRICK & HEYBL, 555 ST. CHARLES DRIVE, SUITE 107, THOUSAND OAKS, CA, 91360, US

(73) Assignee: ANALOG DEVICES, INC.

(21) Appl. No.: 11/639,580

(22) Filed: Dec. 14, 2006

(51) Int. Cl. H04N 5/40

(52) U.S. Cl. 348/724; 348/E05.094

(57) ABSTRACT

Upconverter structures are provided that generate selected television signals with digital upconverters that are coupled between analog-to-digital converters and digital-to-analog converters. Embodiments of the digital upconverters generally include at least one digital quadrature modulator that facilitates the conversion of digital intermediate-frequency sequences to digital broadcast sequences and further include at least one digital interpolation filter that facilitates the conversion of an input sample rate to an output sample rate.

### BACKGROUND OF THE INVENTION

1. Field of the Invention

The present invention relates generally to television signal upconverters.

2. Description of the Related Art

The majority of all television signals originate at a location typically termed a headend. They are then routed to subscribers over a transmission system (e.g., a cable network, one or more satellite transmission beams, or a wireless network that includes ground-based antennas). The signals are generally displayed on a vast installed base of television sets which are configured to receive television channels that are spaced across a frequency span, e.g., from channel 2 at 55.25 MHz to at least channel 125 at 799.25 MHz. Exemplary channel spacings are 6 MHz in the United States and 8 MHz in Europe.

Each of the headend television signals generally begins as modulation information carried on an intermediate-frequency signal (having an intermediate frequency in the general range of 41-47 MHz) which is then upconverted to the frequency of one of the standard television channels. This upconversion is accomplished in a bank of television upconverters which are housed at a television system's headend.

Because of the large number of television channels, this bank of upconverters represents a considerable investment. There would be, therefore, significant value in an upconversion structure that is less expensive than the structure of conventional upconverters which has typically been a super-heterodyne arrangement of analog filters and amplifiers arranged with analog mixers that are driven by fixed and programmable local oscillators.

### BRIEF SUMMARY OF THE INVENTION

The present invention is directed to simple, economical upconverter structures. The drawings and the following description provide an enabling disclosure and the appended claims particularly point out and distinctly claim disclosed subject matter and equivalents thereof.

### BRIEF DESCRIPTION OF THE DRAWINGS

FIG. 1 is a diagram of a bank of television video upconverters;

FIG. 2 is a block diagram of an upconverter embodiment of the present invention which can be used in the bank of FIG. 1;

FIG. 3 is a flow chart that recites structure in the upconverter of FIG. 2;

FIG. 4A is a block diagram of an embodiment of the digital upconverter of FIG. 2 and FIGS. 4B-4F are diagrams that illustrate discrete spectrums at various points in the upconverter of FIG. 4A;

FIG. 5A is a block diagram of another embodiment of the digital upconverter of FIG. 2 and FIGS. 5B-5F are diagrams that illustrate discrete spectrums at various points in the upconverter of FIG. 5A; and

FIG. 6 is a block diagram of another embodiment of the digital upconverter of FIG. 2.

### DETAILED DESCRIPTION OF THE INVENTION

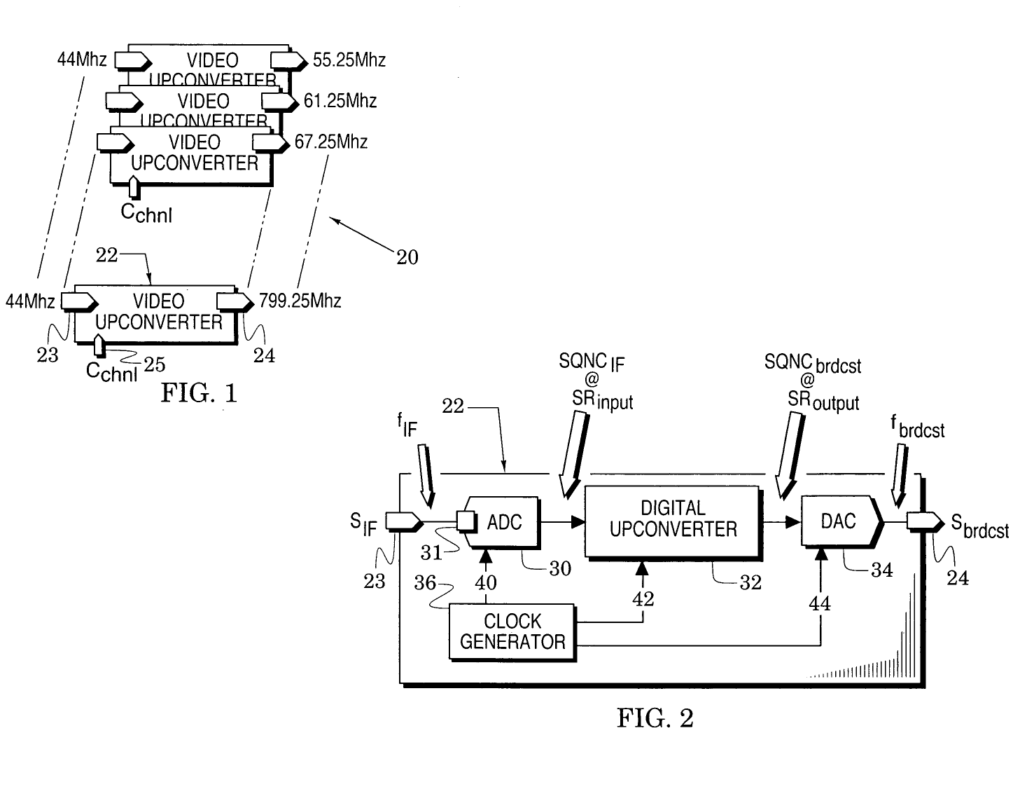

FIGS. 1-7 illustrate upconverter embodiments of the present invention which can be realized with simple digital structures, e.g., arrays of logic gates, and easily set to selected broadcast frequencies. The embodiments generally include at least one digital quadrature modulator that facilitates the conversion of a digital intermediate-frequency (IF) sequence to digital broadcast sequences and further include at least one digital interpolation filter that facilitates the conversion of an input sample rate to an output sample rate.

In particular, FIG. 1 illustrates a bank 20 of video upconverters 22 that each receive, at an input port 23, an analog IF signal at an IF frequency (e.g., 44 MHz) and provide, at an output port 24, an analog broadcast signal having a respective one of a range of broadcast frequencies. The broadcast frequencies may, for example, be spaced every 6 MHz across a range between 55.25 MHz and 799.25 MHz. To simplify fabrication and replacement, each video upconverter 22 is preferably identical to other upconverters of the set and each has a selection port 25 at which a channel command signal C_{chnl} determines the selected broadcast frequency for that upconverter. Thus, video upconverters can be identically manufactured and each can be installed in any position of the bank 20.

An exemplary one of the video upconverters is shown in FIG. 2 to include an analog-to-digital converter (ADC) 30, a digital-to-analog converter (DAC) 34 and a digital upconverter 32 that is coupled between the ADC and the DAC. A clock generator 36 provides a clock signal 40 to the ADC, a clock signal 44 to the DAC, and at least one clock signal 42 to the digital upconverter.

As shown in FIG. 2 by a first signal arrow, an analog IF signal S_{IF} at the input port 23 has an IF frequency f_{IF} which may be the 44 MHz frequency shown in FIG. 1. The ADC 30 converts the analog IF signal having an IF frequency to a digital IF sequence SQNC_{IF} (e.g., a sequence of digital words) that represents the analog IF signal at an input sample rate SRᵢₙₚᵤₜ wherein the input sample rate is controlled by the clock signal 40. In one embodiment, the ADC 30 includes an input sampler 31 that provides samples of the analog IF signal at the input sample rate. It is noted that some television systems may provide a digitized version of the analog IF signal. Accordingly, another embodiment of the video upconverter 22 of FIG. 2 would not include the ADC 30.

As indicated by another signal arrow, the digital upconverter upconverts the digital IF sequence to a digital broadcast sequence SQNC_{brdcst} that represents a respective one of the range of analog broadcast signals at an output sample rate SRₒᵤₜₚᵤₜ. Finally, the DAC 32 operates at the output sample rate and converts the digital broadcast sequence to the selected analog broadcast signal. The selected analog broadcast frequency has a broadcast frequency f_{brdcst} which may, for example, be a selected one from the range of 55.25 MHz to 799.25 MHz that was previously mentioned.

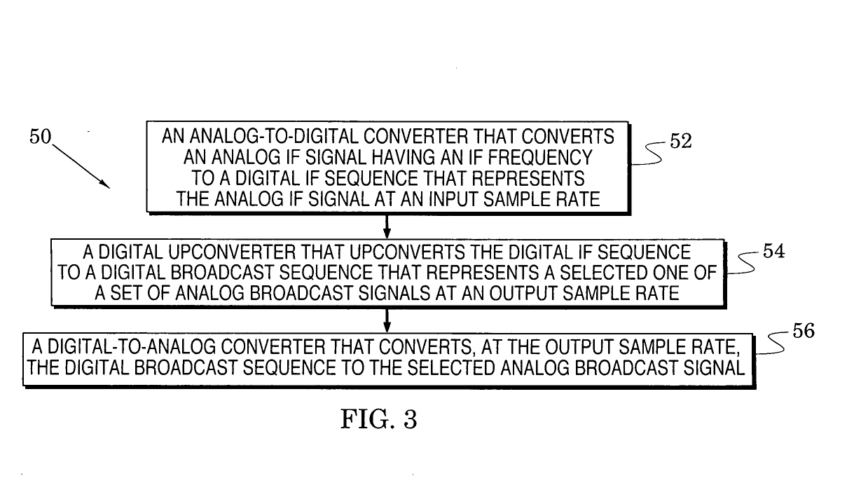

The elements of FIG. 1 and their operational processes are summarized in the steps 52, 54 and 56 of a flow chart 50 that is shown in FIG. 3. The flow chart recites structure for a signal upconverter and begins with step 52 that provides an analog-to-digital converter which converts an analog IF signal having an IF frequency to a digital IF sequence that represents the analog IF signal at an input sample rate (i.e., the input sample rate of the digital upconverter (32 in FIG. 1)).

Step 56 provides a digital-to-analog converter that receives a digital broadcast sequence that represents a selected one of a set of analog broadcast signals at an output sample rate (i.e., the sample rate of the digital-to-analog converter). The digital-to-analog converter then converts the digital broadcast sequence to the selected analog broadcast signal.

Step 54 provides a digital upconverter that operates at the input sample rate of the analog-to-digital converter and the output sample rate of the digital-to-analog converter. Operating at these different rates, the digital upconverter upconverts the digital IF sequence (received from the analog-to-digital converter) to the digital broadcast sequence (required by the digital-to-analog converter).

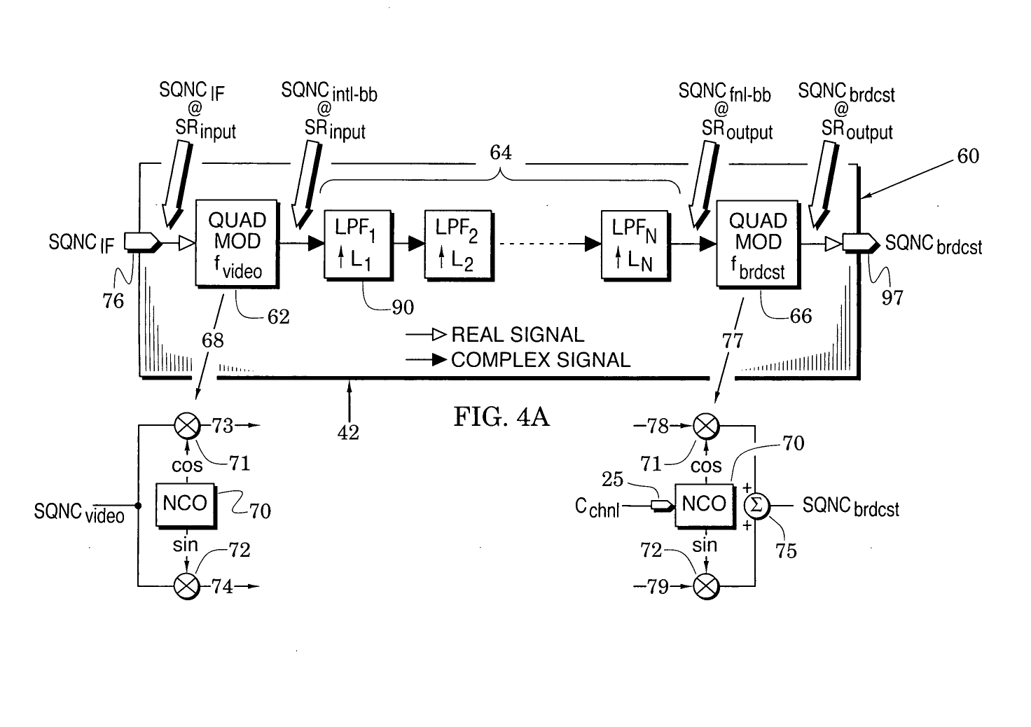

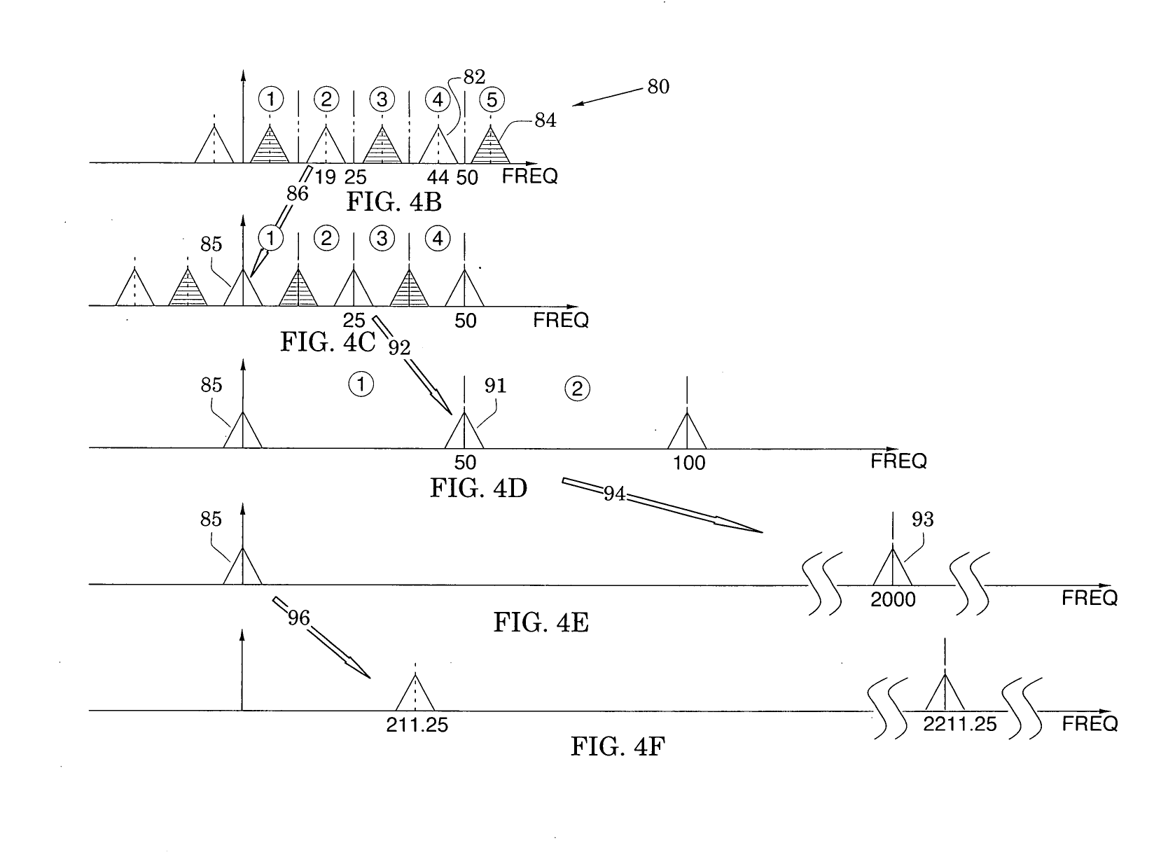

An embodiment 60 of the video upconverter 32 of FIG. 2 is shown in FIG. 4A. This embodiment positions a string 64 of digital lowpass interpolation filters (LPF in FIG. 4A) between an input digital quadrature modulator (QUAD MOD) 62 and an output digital quadrature modulator 66. To facilitate the following description, real signals are represented in FIG. 4A by arrows which have white arrowheads and complex signals (signals that include real and quadrature components) are represented by arrows which have black arrowheads. As shown, all signals between the quadrature modulators are complex digital signals.

Example arrow 68 shows that the initial quadrature modulator 62 may be formed with a numerically controlled oscillator 70 that provides a cosine (cos) sequence and a quadrature sine (sin) sequence to first and second digital multipliers 71 and 72. The IF sequence from the ADC (30 in FIG. 2) is applied to the digital multipliers which generate multiplied sequences 73 and 74 that, together, form the complex signal that exits the input quadrature modulator 62.

The input quadrature modulator 62 receives, through an input port 76, the digital IF sequence SQNC_{IF} that was generated by the ADC (30 in FIG. 2) at an input signal rate SRᵢₙₚᵤₜ. The first quadrature modulator converts this digital sequence to a complex digital initial baseband sequence SQNC_{initl-bb} at the input sample rate SRᵢₙₚᵤₜ.

As indicated by another example arrow 77, the second quadrature modulator 66 may be formed with structure similar to that of the quadrature modulator 62 except for an summer 75. The modulator 66 receives complex sequences 78 and 79 (parts of the digital final baseband sequence SQNC_{fnl-bb}) at the output sample rate SRₒᵤₜₚᵤₜ, multiplies them with appropriate quadrature signals from the NCO 70, and differences the products in the summer 75 to form the broadcast sequence SQNC_{brdcst} at the output signal rate SRₒᵤₜₚᵤₜ.

In contrast to the first quadrature modulator 62, the variable-frequency NCO of the second quadrature modulator 66 provides cos and sin sequence frequencies that are a function of a channel command signal C_{chnl} which is received from the selection port 25 initially shown in FIG. 1. In a modulator embodiment, therefore, the broadcast sequence SQNC_{brdcst} is formed by 78 cos−79 sin wherein 78 and 79 are the complex sequences from the string 64 of digital filters. In another modulator embodiment, the summer 75 can be arranged to form the broadcast sequence SQNC_{brdcst} as 78 cos+79 sin.

At this point, it is noted that the analog IF signal that enters the input port 23 in FIG. 2 is generally centered at 44 MHz and has a bandwidth of 6 MHz in the United States and 8 MHz in Europe. The continuous spectrum of this analog IF signal can thus be shown as a broken line which indicates the original center frequency and sloped lines on either side of the broken line which indicate a total information bandwidth of 8 MHz. A similar signal-bandwidth symbol is shown as corresponding discrete original spectrum 82 in the discrete spectrum 80 of FIG. 4B which also shows a plurality of replicated spectrums 84.

When the ADC 30 of FIG. 2 responds to an analog signal and generates a corresponding digital signal, that digital signal is a digital sequence (e.g., of binary words) which is generated at a sample rate to thereby model or represent the analog signal. Implementing analog signals in the digital domain thus produces digital sequences at corresponding sample rates.

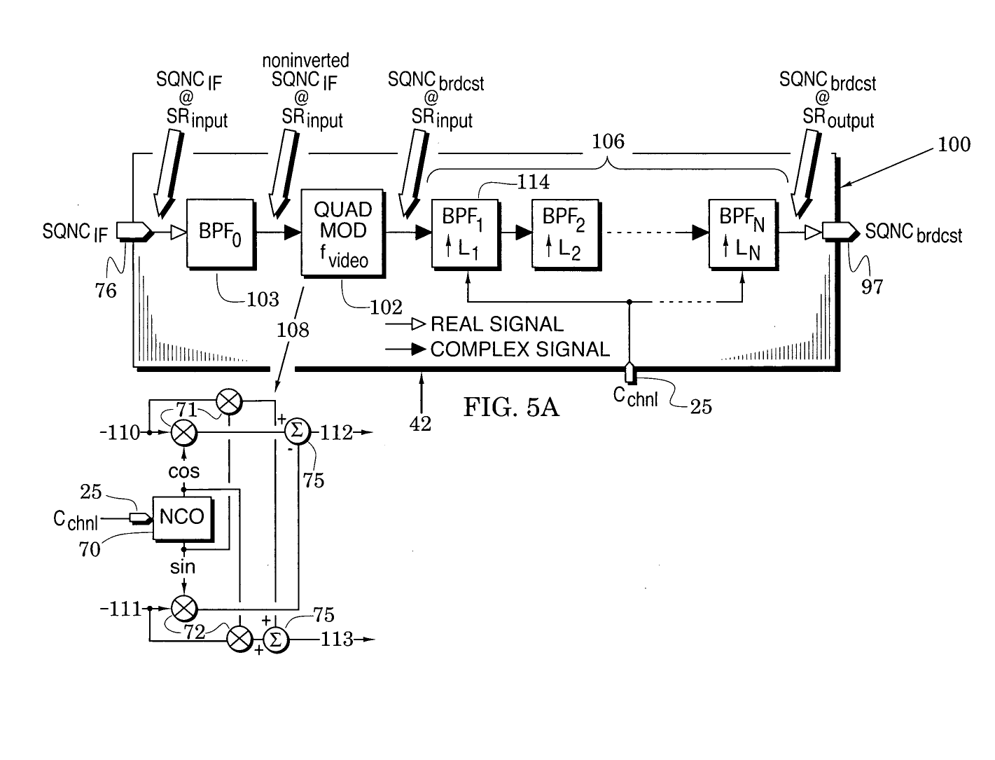

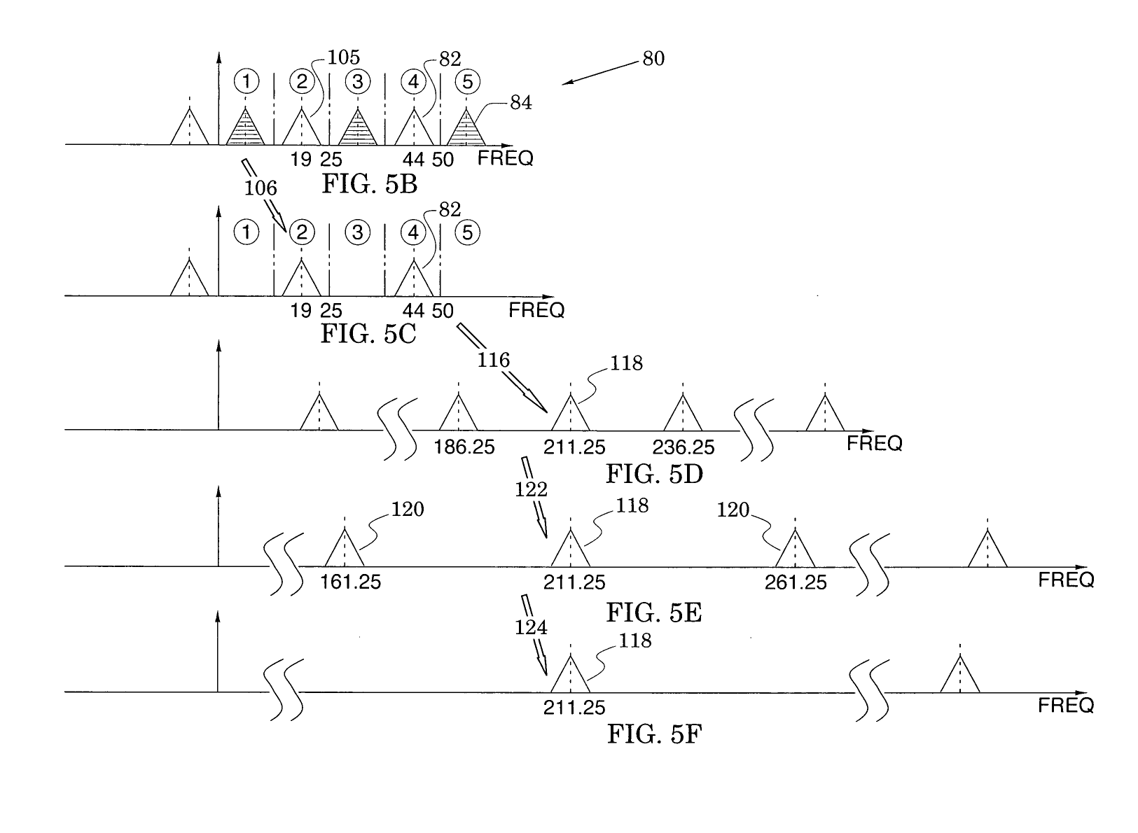

The analog signal has thus been digitally encoded into digital sequences which can be processed, for example, through a digital-to-analog converter to recover the represented analog signal. FIGS. 4B-4F and 5B-5F are frequency-domain representations of digital sequences in digital upconverter embodiments of the invention and, as such, they show discrete spectrums which include original and replicated signal spectrums.

The IF sequence at the input port 76 of FIG. 4A generally includes the original spectrum 82 of FIG. 4B which is centered at 44 MHz and also includes a number of replicated spectrum 84 whose locations are functions of the associated sample rate. In FIG. 4B, the input sample rate (determined by the ADC 30 of FIG. 2) has been set at 25 MHz. This exemplary sample rate positions each of the replicated spectrums 6 MHz from 25 MHz, from baseband, and from multiples of 25 MHz so that each is within a corresponding one of the Nyquist zones that are indicated by circled numbers. Accordingly, some of the replicated spectrums are reversed (e.g., those in Nyquist zones 1, 3 and 5) and these are indicated by horizontal shading lines in FIG. 4B.

In one upconverter embodiment, the NCO 70 of the quadrature modulator 62 is set to −19 MHz so that the replicated spectrum centered at 19 MHz in FIG. 4B is shifted to be a baseband spectrum 85 at the origin as shown in FIG. 4C with the original spectrum and the other replicated spectra similarly shifted. Process arrow 86 indicates this spectral shift. The image-rejection structure of the quadrature modulator insures that modulations of +19 MHz are sufficiently rejected such that they need not be further considered (e.g., they are not shown in FIG. 4B). In a different upconverter embodiment, the NCO 70 of the quadrature modulator 62 can be set to −44 MHz so that the spectrum centered at 44 MHz is shifted to be the baseband spectrum 85 at the origin with other spectrums as shown in FIG. 4C.

In the discrete spectrum embodiment illustrated in FIG. 4C, a first lowpass interpolation filter 90 (of the string 64 of FIG. 4A) doubles the sample rate and subsequently low pass filters so that only the baseband spectrum 85 appears in FIG. 4C along with replicated spectrums 91 at 50 MHz and other harmonics of the increased sample rate which is now 50 MHz. Process arrow 92 tracks this increase in sample rate. It is noted that the filtering process has eliminated the reversed spectrums such as the replicated spectrum 84 of FIG. 4B.

Each subsequent lowpass interpolation filter of the string 64 of FIG. 4A further increases the sample rate and subsequently low pass filters the digital sequence. In an embodiment illustrated in FIG. 4E in which the remaining lowpass interpolation filters interpolate by factors 2, 2 and 10 (i.e., total interpolation of 80), the baseband spectrum 85 is accompanied by a replicated spectrum 93 positioned at 2 GHz (higher replicas and negative replicas are not shown).

Together, the lowpass interpolation filters thus increase the input sample rate SRᵢₙₚᵤₜ to realize the output sample rate SRₒᵤₜₚᵤₜ. Process arrow 94 tracks this further increase in sample rate which terminates in the output sample rate SRₒᵤₜₚᵤₜ. Each of the lowpass interpolation filters of the string 64 is labeled with an upward-directed arrow and the letter L to indicate that it is configured to insert L-1 zero-value samples between each pair of received input samples. Although the filter embodiment illustrated began with three halfband interpolation filters (filters having interpolation factors of two), various other interpolation factors can be used.

In an exemplary process step, the NCO 70 of the output quadrature modulator 66 of FIG. 4A is set to 211.25 MHz by the channel command signal C_{chnl} so that the baseband spectrum 85 is shifted from baseband to a broadcast spectrum at 211.25 MHz as shown in FIG. 4E. This is the frequency of channel 13 as defined by the Electronic Industry Association (EIA) and the National Cable Television Association (NCTA) which define channel locations in the United States.

Process arrow 96 tracks this shift of the baseband digital spectrum to the broadcast spectrum. It is noted that this process moves the replicated spectrum at 2 GHz to 2211.25 MHz and moves a replicated spectrum at −2 GHz (not shown) to −1788.75 MHz. This selected broadcast sequence is thus generated at the output sample rate and provided at an output port 97 of the digital upconverter 60.

Other channel signals can be selected by proper adjustment of the channel command signal C_{chnl}. For example, increasing the frequency of the NCO 70 of the output quadrature modulator 66 to 319.25 MHz (via the channel command signal C_{chnl}) would provide channel 40 as defined by the EIA/NCTA. As another example, a command of a very high frequency channel such as channel 125 at 799.25 MHz would shift the baseband spectrum 85 to a broadcast spectrum at 799.25 MHz and shift the replicated spectrum at −2 GHz to −1200.75 MHz.

This latter example illustrates that as the frequency of the broadcast spectrum varies over a range on the order of 55.25 to 799.25 MHz, the frequency of the next lower replicated spectrum will never exceed −1200.75 MHz and the frequency of the next higher replicated spectrum will always exceed 2055.25 MHz. Because the broadcast spectra are well spaced from the nearest replicated spectra, they are easily rejected by other structures (e.g., an inserted analog filter) in the following DAC (34 in FIG. 2). The clock signal of the clock generator 36 of FIG. 2 is shown in FIG. 4A as a single clock 42 but may, in fact, be various clock signals that are provided to the NCOs 70 and interpolation filters of the string 64.

Another embodiment 100 of the digital upconverter 32 of FIG. 2 is shown in FIG. 5A. This embodiment positions a digital quadrature modulator (QUAD MOD) 102 between an initial complex bandpass filter 103 and a string 106 of digital bandpass interpolation filters. As in FIG. 4A, real signals are represented in FIG. 5A by arrows which have white arrowheads and complex signals are represented by arrows which have black arrowheads. All signals between the initial bandpass filter and the last bandpass interpolation filter of the string 106 are complex signals.

The discrete spectrum 80 of FIG. 4B is shown again in FIG. 5B to indicate that it is the IF sequence SQNC_{IF} at the input port 76 of FIG. 5A. This IF sequence was generated by the ADC 30 of FIG. 1 at the input signal rate SRᵢₙₚᵤₜ. The complex bandpass filter 103 (labeled BPF₀) is centered on either the original spectrum 82 in the fourth Nyquist zone or on the replicated spectrum 105 in the second Nyquist zone. This bandpass filter is configured (e.g., as a Hilbert transformer) so that it rejects the inverted replicated spectrums 84 that are present in, for example, Nyquist zones 1, 3 and 5 of FIG. 5B.

Accordingly, FIG. 5C shows that only the original spectrum 82 and noninverted replicated spectrums (e.g., the noninverted replicated spectrum 105) are present at the input of the quadrature modulator 102 of FIG. 5A. This process of rejecting the inverted replicated spectrums is indicated by process arrow 106 in FIG. 5C and FIG. 5A shows that a noninverted IF sequence SQNC_{IF} is present at the input of the quadrature modulator 102 at the input sample rate.

Example arrow 108 in FIG. 5A indicates that the quadrature modulator 102 comprises digital multipliers 71, digital multipliers 72, summers 75 and a numerically controlled oscillator 70 (initially shown in FIG. 4A) whose frequency responds to a channel command signal C_{chnl} at the selection port 25. In contrast to the quadrature modulator 66 of FIG. 4A, the quadrature modulator 102 receives complex signals 110 and 111 from the complex bandpass filter 103 and provides complex signals 112 and 113 to the string 106.

In the modulator embodiment of FIG. 5A, the numerically controlled oscillator 70 provides a cosine (cos) sequence and a quadrature sine (sin) sequence and the multipliers 71 and 72 and summers 75 are arranged so that complex signal 112 is formed by 110 cos−111 sin and the complex signal 113 is formed by 110 sin+111 cos. Various other structural embodiments can be used to obtain other modulator embodiments which provide broadcast sequence SQNC_{brdcst} embodiments.

In an exemplary process, frequency of the numerically controlled oscillator 70 is set so that the original spectrum 82 of FIG. 5C is shifted to shifted to a broadcast spectrum at 211.25 MHz as shown in FIG. 5D. As previously noted, this is the frequency of channel 13 as defined by the EIA/NCTA. Thus, the quadrature modulator 102 provides a broadcast sequence SQNC_{brdcst} at the input signal rate SRᵢₙₚᵤₜ to the string 106 of bandpass interpolation filters. With a process arrow 116, FIG. 5D shows that the original spectrum 82 of FIG. 5C has been shifted to a broadcast spectrum 118 at 211.25 MHz with the nearest replicated spectrums 25 MHz below and above the broadcast spectrum.

Also in response to the channel command signal C_{chnl} at the selection port 25, the bandpass interpolation filters of the string 106 of FIG. 5A are centered on the broadcast spectrum 118 at 211.25 MHz. The first bandpass interpolation filter 114 may be set to an interpolation factor of two so that the distance to the nearest replicated spectrums 122 is doubled. This bandpass interpolation action is indicated by a process arrow 122 in FIG. 4D.

Each successive bandpass interpolation filter of the string (106 in FIG. 5A) further increases the distance to the nearest replicated spectrums 122 so that the broadcast spectrum 118 remains at 211.25 MHz but is isolated by significant frequency distances from the nearest replicated spectrum. This bandpass interpolation action is indicated by a process arrow 124. Because the broadcast spectrum are all well spaced from the nearest replicated spectrum, they are easily rejected by other structures (e.g., an inserted analog filter) in the following DAC (34 in FIG. 2).

When sample rates increase by an interpolation factor L, the computational operations required to realize the filter increase by 2L because the data processed and the filter length both increase by L. Accordingly, the computational load for digital upconverter embodiments of the invention may be reduced by appropriate selection of which filters are realized at lower input sample rates and which are realized at higher sample rates. For example, halfband interpolation filters (i.e., filters with an interpolation factor of 2) are computationally efficient and proper filter selections facilitate their realization with a plurality of polyphase filter sections which are also computationally efficient.

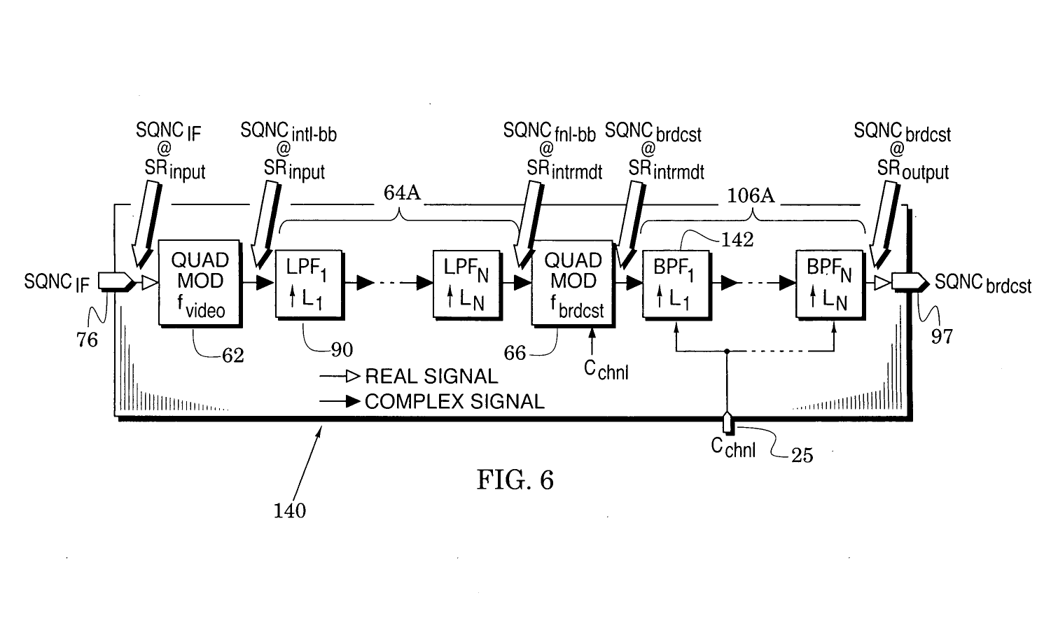

Therefore, FIG. 6 illustrates another digital upconverter embodiment 140 which may provide the opportunity for reducing computational loads. At an input port 76, the upconverter 140 receives the digital IF sequence SQNC_{IF} that was generated by the ADC at an input signal rate SRᵢₙₚᵤₜ. A first quadrature modulator 62 (introduced in FIG. 4A) converts this digital sequence to a complex digital initial baseband sequence SQNC_{initl-bb} at the input sample rate SRᵢₙₚᵤₜ.

A string 64A of lowpass interpolation filters similar to the string 64 introduced in FIG. 4A then converts the initial baseband sequence to a final baseband sequence SQNC_{fnl-bb}) at an intermediate sample rate SR_{intrmdt}. The string 64 of FIG. 6 is thus similar to that of FIG. 4A (it may, for example, begin with the filter 90) but it terminates with a digital sequence at an intermediate sample rate rather than the output sample rate of the string 60 in FIG. 4A.

A quadrature modulator 66 (introduced in FIG. 5A) then responds to a channel command signal C_{chnl} to thereby shift a baseband spectrum, received from the string 64A, to a broadcast spectrum at a channel frequency (e.g., the broadcast spectrum at 211.25 MHz shown in FIG. 5D). This broadcast spectrum represents a selected one of analog broadcast signals at the intermediate sample rate SR_{intrmdt}.

A string 106A of bandpass interpolation filters then converts the broadcast sequence SQNC_{brdcst} at the intermediate signal rate SR_{intrmdt} to a broadcast sequence SQNC_{brdcst} at the output signal rate SRₒᵤₜₚᵤₜ. In a manner similar to that of the string 106 of FIG. 5A, the frequency of the string 106A is set by the channel command signal C_{chnl} at the selection port 25. The string 106A may, for example, begin with a bandpass filter 142 that is similar to the bandpass filter 114 of FIG. 5A except that it operates at a different sample rate. The digital upconverter 140 thus comprises lowpass and bandpass interpolation filters that operate at various sample rates from an input sample rate (that of the ADC 30 in FIG. 2) to an output sample rate (that of the DAC 34 in FIG. 2). This embodiment enhances selection of filter combinations that can be selected to reduce the computational load.

Structures of the upconverter embodiments of the invention can be realized with arrays of appropriately-coupled logic gates, with appropriately-programmed digital processors or with combinations thereof.

Although it is noted that the numerically-controlled oscillators, multipliers and summers of FIGS. 4A, 5A and 6 generally operate at different rates, common reference numbers 70, 71, 72 and 75 have, for simplicity of illustration and description, been used for these quadrature modulator structures.

The embodiments of the invention described herein are exemplary and numerous modifications, variations and rearrangements can be readily envisioned to achieve substantially equivalent results, all of which are intended to be embraced within the spirit and scope of the appended claims.

I claim:

1. A signal upconverter, comprising:
a digital upconverter that upconverts a digital intermediate-frequency (IF) sequence which represents an analog IF signal at an input sample rate to a digital broadcast sequence which represents a selected one of a set of analog broadcast signals at an output sample rate that exceeds said input sample rate; and
a digital-to-analog converter that converts, at said output sample rate, said digital broadcast sequence to said selected analog broadcast signal.

2. The upconverter of claim 1, further including an analog-to-digital converter that converts an analog intermediate-frequency (IF) signal having an IF frequency to said digital IF sequence.

3. The upconverter of claim 2, wherein a frequency-domain representation of said digital IF sequence includes an original spectrum and said input sample rate positions said original spectrum within one Nyquist zone.

4. The upconverter of claim 1, wherein said output sample rate is an integer multiple of said input sample rate.

5. The upconverter of claim 1, wherein said digital upconverter includes:
at least one digital quadrature modulator that facilitates the conversion of said digital IF sequence to said digital broadcast sequence; and
at least one digital interpolation filter that facilitates the conversion of said input sample rate to said output sample rate.

6. The upconverter of claim 5, wherein said digital interpolation filter is a lowpass interpolation filter.

7. The upconverter of claim 5, wherein said digital interpolation filter is a bandpass interpolation filter.

8. The upconverter of claim 1, wherein said digital upconverter includes:
an input digital quadrature modulator that converts said digital IF sequence to a digital initial baseband sequence at said input sample rate;
a string comprising at least one digital lowpass interpolation filter wherein said string converts said digital initial baseband sequence to a digital final baseband sequence at said output sample rate; and
an output digital quadrature modulator that converts said digital final baseband sequence to said digital broadcast sequence.

9. The upconverter of claim 8, wherein said output digital quadrature modulator includes a numerically controlled oscillator which, in response to a channel command signal, provides oscillator sequences that alter said digital final baseband sequence into said digital broadcast sequence.

10. The upconverter of claim 8, wherein:
said input digital quadrature modulator includes a numerically controlled oscillator that generates digital oscillator sequences which represent, at said input sample rate, analog cosine and sine signals having said IF frequency; and
said output digital quadrature modulator includes a numerically controlled oscillator that generates digital oscillator sequences which represent, at said output sample rate, analog cosine and sine signals having a frequency substantially equal to said broadcast frequency less said IF frequency.

11. The upconverter of claim 1, wherein said digital upconverter includes:
a complex digital bandpass filter that rejects inverted replicated spectrum from said digital IF sequence to thereby provide a noninverted digital IF sequence at said input sample rate;
a digital quadrature modulator that converts said noninverted digital IF sequence to a broadcast sequence that represents said selected analog broadcast signal at said input sample rate; and
a string comprising at least one digital bandpass interpolation filter wherein said string converts said broadcast sequence at said input sample rate to said broadcast sequence at said output sample rate.

12. The upconverter of claim 11, wherein said digital quadrature modulator includes a numerically controlled oscillator which, in response to a channel command signal, provides oscillator sequences that alter said noninverted digital IF sequence into said digital broadcast sequence.

13. The upconverter of claim 11, wherein said digital quadrature modulator includes a numerically controlled oscillator that generates digital oscillator sequences which represent, at said input sample rate, analog cosine and sine signals having a frequency substantially equal to said broadcast frequency less said IF frequency.

14. The upconverter of claim 1, wherein said digital upconverter includes:
an input digital quadrature modulator that converts said digital IF sequence to a digital initial baseband sequence at said input sample rate;
a baseband string comprising at least one digital lowpass interpolation filter wherein said string converts said digital initial baseband sequence to a digital final baseband sequence at an intermediate sample rate;
an output digital quadrature modulator that converts digital final baseband sequence to a broadcast sequence at said intermediate sample rate; and
a broadcast string comprising at least one digital bandpass interpolation filter wherein said string converts said broadcast sequence at said intermediate sample rate to said broadcast sequence at said output sample rate.

15. A bank of signal upconverters, comprising:
a plurality of upconverters that each include:
a digital upconverter that upconverts a digital intermediate-frequency (IF) sequence which represents an analog IF signal at an input sample rate to a digital broadcast sequence which represents a selected one of a set of analog broadcast signals at an output sample rate that exceeds said input sample rate; and
a digital-to-analog converter that converts, at said output sample rate, said digital broadcast sequence to said selected analog broadcast signal.

16. The bank of claim 15, wherein each of said upconverters further includes an analog-to-digital converter that converts an analog intermediate-frequency (IF) signal having an IF frequency to said digital IF sequence.

17. The bank of claim 15, wherein said set of analog broadcast signals have broadcast frequencies between 55.25 megahertz and 799.25 megahertz.

18. The bank of claim 15, wherein said digital upconverter includes:
an input digital quadrature modulator that converts said digital IF sequence to a digital initial baseband sequence at said input sample rate;
a string comprising at least one digital lowpass interpolation filter wherein said string converts said digital initial baseband sequence to a digital final baseband sequence at said output sample rate; and
an output digital quadrature modulator that converts said digital final baseband sequence to said digital broadcast sequence.

19. The bank of claim 15, wherein said digital upconverter includes:
a complex digital bandpass filter that rejects inverted replicated spectrum from said digital IF sequence to thereby provide a noninverted digital IF sequence at said input sample rate;
a digital quadrature modulator that converts said noninverted digital IF sequence to a broadcast sequence that represents said selected analog broadcast signal at said input sample rate; and
a string comprising at least one digital bandpass interpolation filter wherein said string converts said broadcast sequence at said input sample rate to said broadcast sequence at said output sample rate.

20. The bank of claim 15, wherein said digital upconverter includes:
an input digital quadrature modulator that converts said digital IF sequence to a digital initial baseband sequence at said input sample rate;
a baseband string comprising at least one digital lowpass interpolation filter wherein said string converts said digital initial baseband sequence to a digital final baseband sequence at an intermediate sample rate;
an output digital quadrature modulator that converts digital final baseband sequence to a broadcast sequence at said intermediate sample rate; and
a broadcast string comprising at least one digital bandpass interpolation filter wherein said string converts said broadcast sequence at said intermediate sample rate to said broadcast sequence at said output sample rate.
